(19) United States
(12) Patent Application Publication
(10) Pub. No.: US 2007/0022382 A1
(43) Pub. Date: Jan. 25, 2007

(54) Digital content management user interface, apparatus and system thereof

(76) Inventor: Petteri Honkaniemi, Helsinki (FI)

Correspondence Address: YOUNG & THOMPSON, 745 SOUTH 23RD STREET, 2ND FLOOR, ARLINGTON, VA, 22202, US

(21) Appl. No.: 11/186,846

(22) Filed: Jul. 22, 2005

(51) Int. Cl. G06F 9/00

(52) U.S. Cl. 715/733; 715/838; 715/769; 715/835

(57) ABSTRACT

A digital content management user interface is based on Internet communications. The digital content includes items, each item having a media file and arranged to be visible as a thumbnail on the user interface. The items are arranged to establish at least one playlist so that a series of thumbnails are arranged to establish the playlist. The thumbnails are visible on the playlist. The user interface including: A first editor panel having three views for the loop, the playlist and the items respectively, the views being individually selectable. A second editor panel comprising three views for the loop, the playlist and the items respectively, the views being individually selectable. Elements for communicating data of the items, the playlist and the loop via the Internet. The interface includes also elements for drag and drop at least one thumbnail from the first editor panel to the second editor panel when the panel views are different for establishing the playlist or the loop.

### TECHNICAL FIELD OF THE INVENTION

The invention concerns a digital content management user interface. Furthermore the invention concerns an apparatus comprising the digital content management user interface. Yet furthermore, the invention concerns a system for managing digital content. Yet furthermore the invention concerns the use of the interface, the apparatus and the system.

### RESERVATION OF COPYRIGHT

A portion of the disclosure of this patent document contains material to which a claim of copyright protection is made. The copyright owner has no objection to the facsimile reproduction by anyone of the patent document or the patent disclosure as it appears in Patent Office file or records, but reserves all other rights whatsoever.

### BACKGROUND ART

A distribution and management of media files in the Internet has awoken great deal of interest. This is because of the benefit of Internet offering superior communications way. Internet offers connections to various locations worldwide. Furthermore these days Internet is able to distribute large number of data enabling delivery of large media files such as digital video. However, the user friendliness of Internet has not followed the success.

A known system for distribution and management of the media files by a user interface via Internet has been based on entering of URL. Thus user has had to define a detailed URL address for identifying source and/or the destination of the media file. In case of several files and distribution terminals, this is too difficult task and cumbersome to handle by a layman operating in the content business.

### SUMMARY OF THE INVENTION

It is therefore the object of the invention to allow a user to create and manipulate digital media content presentation easily.

In accordance with a first aspect of the invention there is provided a digital content management user interface, which is based on Internet communications. The digital content comprises items, each item comprising a media file and arranged to be visible as a thumbnail on the user interface. The items are arranged to establish at least one playlist so that a series of thumbnails are arranged to establish said playlist. The thumbnails are visible on the playlist. The user interface comprises a first editor panel comprising views for the playlist and the items respectively, the views being individually selectable. A second editor panel comprising views for the playlist and the items respectively, the views being individually selectable. Means for communicating data of the items and the playlist via the Internet. The interface comprises also means for drag and drop at least one thumbnail from the first editor panel to the second editor panel when the panel views are different for establishing the playlist.

In accordance with a second aspect of the invention there is provided an apparatus comprising the user interface.

In accordance with a third aspect of the invention there is provided a system for managing digital content, which is based on Internet communications, the system comprising:

a computer comprising a digital content management user interface. The digital content comprises items, each item comprising a media file and arranged to be visible as a thumbnail on the user interface. The items are arranged to establish at least one playlist so that a series of thumbnails are arranged to establish said playlist. The playlist is arranged to establish at least one loop so that said series of thumbnails are arranged to establish at least a part of the loop. The thumbnails are visible on the playlist and on the loop, the user interface comprising:

A first editor panel comprising three views for the loop, the playlist and the items respectively, the views being individually selectable. A second editor panel comprising three views for the loop, the playlist and the items respectively, the views being individually selectable. Means for drag and drop at least one thumbnail from the first editor panel to the second editor panel when the panel views are different for establishing the playlist or the loop. Means for communicating data of the items, the playlist and the loop via the Internet with at least one terminal for presenting of the digital content.

Various embodiments of the invention provide the user interface that is designed to allow users to create and manipulate its content easily for a plurality of presentation terminals via Internet. The user interface allows user to manipulate loops, playlists and content items.

In various further embodiments, the data corresponding to the items is remotely storageable via the Internet. A plurality of terminals, which are arranged to present the playlist, receives the digital content corresponding to the playlist via the Internet from at least one remote server storing said digital content generally. Furthermore the digital content presented by the playlist in each terminal of the terminals is individually controllable by the user interface.

Yet further embodiments of the invention have been specified in the dependent claims.

### BRIEF DESCRIPTION OF THE DRAWINGS

The invention will now be described, by way of examples only, with reference to the accompanying drawings, in which:

FIG. 1 depicts an example of a user interface where a loop view and a playlist view are depicted in accordance with a further embodiment of the invention,

FIG. 2 depicts an example of a user interface where a playlist view and an item view are illustrated in accordance with another further embodiment of the invention,

FIG. 3 depicts an example of a user interface where a loop view and an item view are illustrated in accordance with another further embodiment of the invention,

FIG. 4 depicts a system for managing digital content, where various embodiments of the invention may be applied.

### DESCRIPTION OF FURTHER EMBODIMENTS

The user interface of various further embodiments is Internet browser based remote control graphical interface (GUI) for digital content management system (CMS).

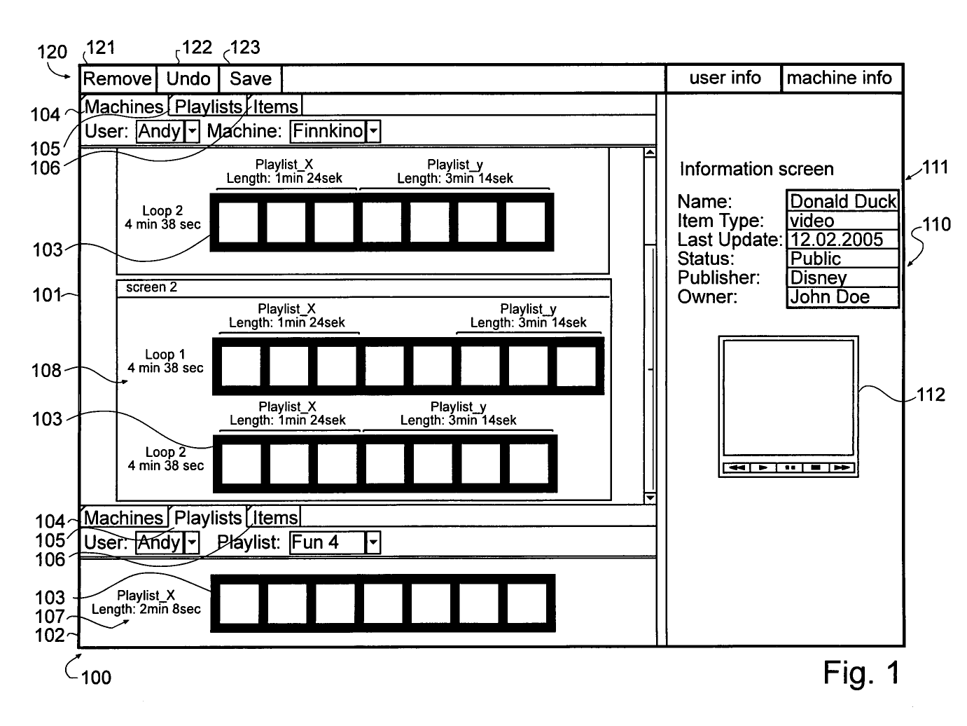

Referring to further embodiments of FIG. 1 there is being depicted an example of a user interface 100. User interface 100 can be designed to edit digital content such as digital video via Internet. The user interface 100 allows user to manipulate loops, playlists and items. User interface 100 is separated into three different parts: a menu 120, editor screens and information screen 110. The editor screen comprises (or is divided to) two different editor panels 101,102. In further embodiments the editor panels 101,102 are identical.

One editor panel 101 or 102 can change view to machine view 104, playlist view 105 or items view 106. The machine view 104 shows a loop 108. The machine view furthermore controls at least one terminal, where the loop 108 is presented. The machine view 104 can control various terminals or alternatively referred to as screens or the like. The terminals are controlled via Internet communications. Loops 108 include the content, which will be shown from the screen such as a TV screen. Thus one TV screen consists of one or multiple loops 108. The loop 108 can contain playlists 107 and items 103.

Thus a playlist 107 comprises items 103. The item 103 is a media file, which can be for example a movie or a picture file. The playlist 107 has a series of items as shown in FIG. 1. The order can be significant scheduling the items within the playlist 107. Also as shown in FIG. 1 the loop 108 comprises a series of playlists. Furthermore the loop 108 shows the items scheduled within the playlist and the loop.

The command menu 120 shows buttons for controlling the management of the content like remove 121, undo 122 and save 123. Various further embodiments relate also to the information view 110 showing information from one item, playlist, loop, user or machine. User can change this information if he/she is allowed to do that. The information view 110 shows textual information 111 about the item. Furthermore the information view 110 shows a preview 112 such as a video clip about the selected item.

Two editor panels 101,102 allows user to make the changes as easily. For example, if user wants to add the playlist 107 to the loop 108, he/she just opens the machines view 104 to the first editor panel 101 and playlists view 105 to the second editor panel 102. User can choose the machine, which he/she wants to edit. Thus user selects the computer or screen corresponding to the respective loop. Playlists can be selected the same way. After that, user just drags and drops the playlist 107 to the loop 108. Thereby, the digital video content management is easy and simple even for a non-technical person.

In various further embodiments, the machine view 104, the playlist view 105 and the items view 106 communicate by Internet connections with terminals presenting the digital content and with servers storing the actual data of the digital content.

In various further embodiments the machine view 104 playlist can contain many playlists that establishes the loop 108. Furthermore a physical computer containing the screen for presenting the digital content can have four states, which have the same or different playlists.

In addition the user can change the size of the panels (the editor panels and the information panels) in the user interface, preferably within the browser.

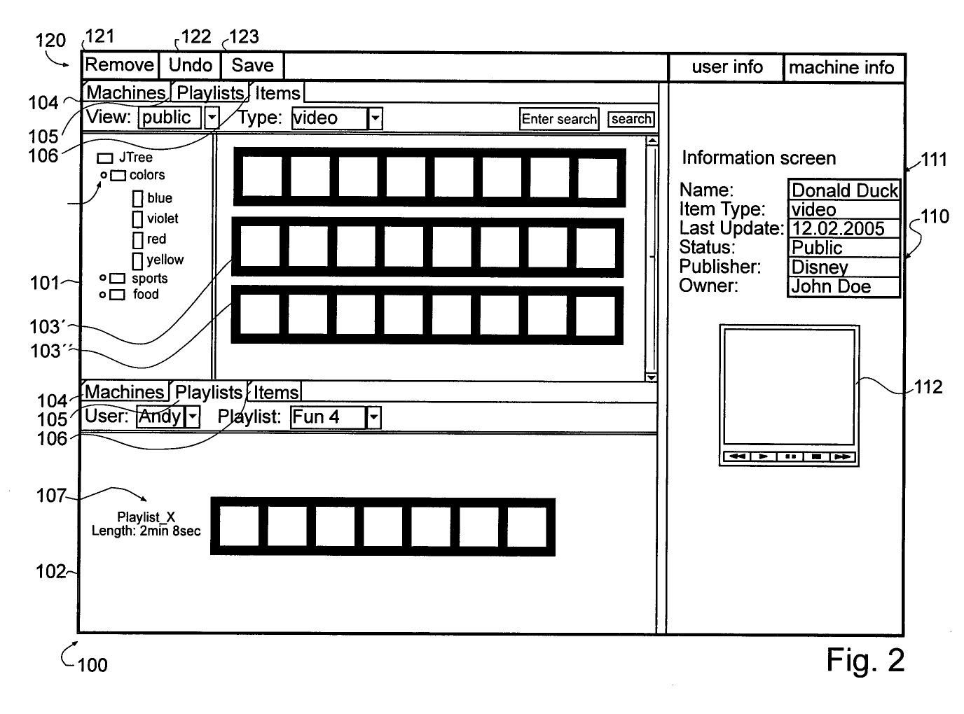

Referring now to FIG. 2 there is being depicted another example of the user interface 100 where the playlist view 105 and the item view 106 are illustrated. If user wants to create or edit the playlist 107, he/she can choose the items view 106 to the first editor panel 101 and drag and drop items 103′, 103″ to the playlist 107. User can choose items 103′, 103″ by the category from a tree selector 200. Alternatively user can search items by using the search phrase. The same category shows related items within the associated connection.

The information panel 110 shows information about the selected item. User can also see the preview 112 in the information panel 110. Preview can be for example a video file.

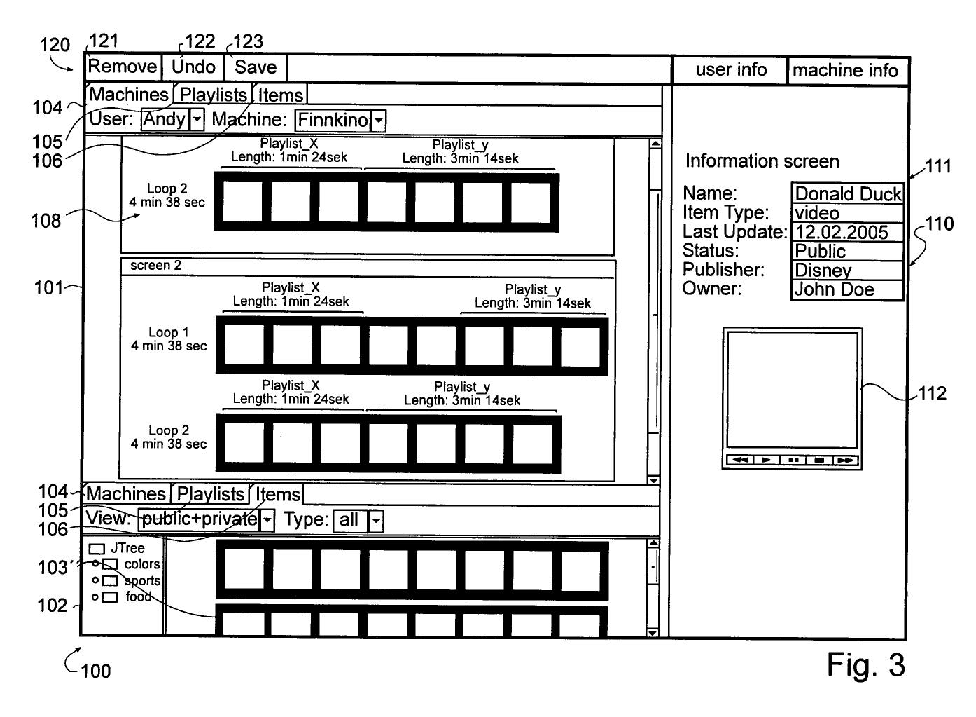

Referring now to FIG. 3 there is being depicted yet another example of the user interface 100 where the loop view 104 and the item view 106 are illustrated. If user wants to add items 103′″ directly to the loop 108, he/she can choose the item view 106 and the playlist view 105 and then just drag and drop the item 103′″ and/or various items to the loop 108. Various loops can be edited this way.

If user wants to remove item or playlist, he/she just selects the item and pushes the remove button 121 in the menu 120. Every change will be saved when the user pushes the save button 123. If something goes wrong, user can use the undo button 122 which will change the programs state to match the last save state. Every change will be lost that was done after the previous save.

Various Further Implementations

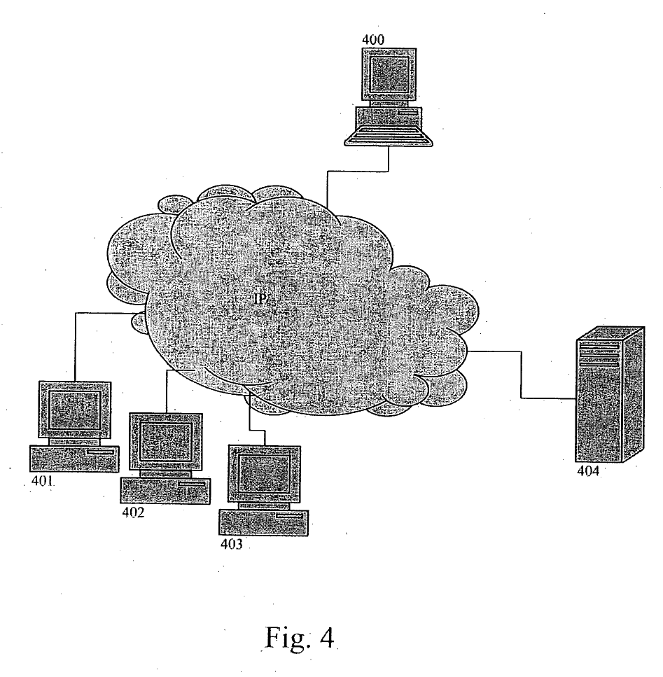

The user interface 100 can be Java based applet designed to edit content on Internet network. FIG. 4 depicts a system for managing digital content, where various embodiments of the invention may be applied. A computer 400 is coupled with screens 401,402 and 403 via Internet. As noted the screens can be alternatively referred to as terminals presenting the digital content. The system can comprise a plurality of terminals. The computer 400 contains the user interface 100 for managing the digital content to be presented on screens 401,402 and 403. It should be noted that even the single computer 400 can manage various screens. Alternatively there can be various computers for managing the content also. The screens 401, 402 and 403 can have a computing device also for the presentation of the media file such as digital video.

Alternatively the screens can be referred to as a digital signage. The digital signage or digital sign is a display device, which is used as an in-store sign to present constantly changing, computer generated, full motion video, photo-realistic graphics, text, and animation. It is a dynamic venue as opposed to static billboards and posters. Examples of display devices that can be used in digital signage networks include: plasma monitors, LCD monitors, CRT monitors, projection displays and kiosks.

Various further embodiments comprise a server 404 in the Internet storing the digital content so that the content management computer 400 may only preview the items without a need to transfer the entire item therein. Thus the data of the items may be needed to transfer to the screen 401, 402 and 403 from the server 404.

The Internet communication can be based on IP multicasting, IP datacasting or alternatively referred to as narrowcasting. Thus the system can be a closed network comprising the computer 400, the server 404 and the screens 401, 402 and 403.

Various further embodiments of the invention are applicable in mobile system. Thus the screens 401, 402 and 403 can be mobile terminals as well as the computer 400. The connection between the screens 401, 402 and 403 and the computer 400 can be a mobile Internet network.

Various embodiments of the invention use thumbnails to symbolise the digital content. The system of the embodiments presents media files such as mp3, vmw, video and picture and accordingly controls the channel of the receiving terminal. In the case of the video, the computer containing the user interface retrieves generally the first picture of the video. Thereby the user comfortably sees a glimpse of the content of the video without any other preview action. The thumbnail of the picture and music is predetermined.

Ramifications and Scope

Although the description above contains many specifics, these are merely provided to illustrate the invention and should not be constructed as limitations of the scope of the invention. It should be also noted that the many specifics can be combined in various ways in a single or multiple embodiments. Thus it will be apparent to those skilled in the art that various modifications and variations can be made in the user interfaces, apparatuses, systems and methods of the present invention without departing form the spirit or scope of the invention.

1. A digital content management user interface, which is based on Internet communications, wherein the digital content comprises items, each item comprising a media file and arranged to be visible as a thumbnail on the user interface, wherein the items are arranged to establish at least one playlist so that a series of thumbnails are arranged to establish said playlist, wherein said thumbnails are visible on the playlist, the user interface comprising:
a first editor panel comprising views for the playlist and the items respectively, the views being individually selectable,
a second editor panel comprising views for the playlist and the items respectively, the views being individually selectable,
means for communicating data of the items and the playlist via the Internet, and
means for drag and drop at least one thumbnail from the first editor panel to the second editor panel when the panel views are different for establishing the playlist.

2. A user interface according to claim 1, wherein data corresponding to the items is remotely storageable via the Internet.

3. A user interface according to claim 2, wherein a plurality of terminals, which are arranged to present the playlist, receives the digital content corresponding to the playlist via the Internet from at least one remote server storing said digital content generally.

4. A user interface according to claim 3, wherein the digital content presented by the playlist in each terminal of said plurality of terminals is individually controllable by the user interface.

5. A user interface according to claim 1, wherein the user interface is Internet browser based user interface.

6. A user interface according to claim 1, wherein said means for drag and drop at least one thumbnail comprise means for drag and drop a plurality of thumbnails.

7. A user interface according to claim 1, wherein the playlist is arranged to establish at least one loop so that said series of thumbnails are arranged to establish at least a part of the loop, the panels comprises further a loop view, said means for communications communicates data of the loop, and said means for drag and drop are arranged to further establish the loop.

8. A user interface according to claim 7, wherein the loop comprises a time line based scheduling for presentation of the digital content that the loop contains.

9. A user interface according to claim 1, wherein the user interface further comprises a menu comprising remove, undo and save commands for controlling the digital content management.

10. A user interface according to claim 1, wherein the user interface further comprises an information panel arranged to show information about a selected item from said items.

11. A user interface according to claim 1, wherein said information comprises text information and video clip about the selected item.

12. A user interface according to claim 1, wherein the panels are generally identical.

13. A user interface according to claim 1, wherein the views are visible in each panel one by one.

14. A user interface according to claim 1, wherein said means for communicating data of the items and the playlist via the Internet comprises means for receiving the data content via Internet corresponding to the item and means for sending the playlist for presentation via Internet.

15. A user interface according to claim 1, wherein the user interface further comprises means for managing a plurality of terminals arranged to present the playlist.

16. A user interface according to claim 15, wherein each terminal is separately controllable with respect to the content by said user interface.

17. A user interface according to claim 1, wherein the playlist is presentable on at least one monitor.

18. An apparatus comprising a digital content management user interface, which is based on Internet communications, wherein the digital content comprises items, each item comprising a media file and arranged to be visible as a thumbnail on the user interface, wherein the items are arranged to establish at least one playlist so that a series of thumbnails are arranged to establish said playlist, wherein said thumbnails are visible on the playlist, the apparatus comprising:
a first editor panel comprising views for the playlist and the items respectively, the views being individually selectable,
a second editor panel comprising views for the playlist and the items respectively, the views being individually selectable,
means for communicating data of the items and the playlist via the Internet, and
means for drag and drop at least one thumbnail from the first editor panel to the second editor panel when the panel views are different for establishing the playlist.

19. A system for managing digital content, which is based on Internet communications, the system comprising:
a computer comprising a digital content management user interface,
wherein the digital content comprises items, each item comprising a media file and arranged to be visible as a thumbnail on the user interface, wherein the items are arranged to establish at least one playlist so that a series of thumbnails are arranged to establish said playlist, wherein the playlist is arranged to establish at least one loop so that said series of thumbnails are arranged to establish at least a part of the loop, wherein said thumbnails are visible on the playlist and on the loop, the user interface comprising:
a first editor panel comprising three views for the loop, the playlist and the items respectively, the views being individually selectable,
a second editor panel comprising three views for the loop, the playlist and the items respectively, the views being individually selectable,
means for drag and drop at least one thumbnail from the first editor panel to the second editor panel when the panel views are different for establishing the playlist or the loop, and
means for communicating data of the items, the playlist and the loop via the Internet with at least one terminal for presenting of the digital content.

20. A system according to claim 19, wherein said means for communicating comprises means for communicating data of the items, the playlist and the loop via the Internet with a plurality of terminals for presenting of the digital content at the terminals.
